(19) United States
(12) Patent Application Publication
(10) Pub. No.: US 2003/0043203 A1
(43) Pub. Date: Mar. 6, 2003

(54) System and method for developing strategic options

(76) Inventors: Renee E. Dye, Atlanta, GA (US); Charles F. Roxburgh, London (GB)

Correspondence Address: COVINGTON & BURLING, ATTN: PATENT DOCKETING, 1201 PENNSYLVANIA AVENUE, N.W., WASHINGTON, DC, 20004-2401, US

(21) Appl. No.: 09/942,929

(22) Filed: Aug. 31, 2001

(51) Int. Cl. G09G 5/00

(52) U.S. Cl. 345/810

(57) ABSTRACT

The present invention provides a computer implemented system and method for facilitating the development of strategic options. As embodied in a computer system, the invention, for example, prompts a user to generate strategic options. As the user inputs strategic options in response to the prompt, the options are received, stored, and organized into a list of strategic options. From the list of strategic options, one or more strategic options may be selected for further analysis using predetermined implementation criteria. In one embodiment implemented on a computer system, the present invention enables a user to perform more than one strategic option exercise to develop a number of strategic options.

### BACKGROUND OF THE INVENTION

1. Field of the Invention

This invention relates to conducting interactive computer-based exercises to facilitate the generation and development of strategic options.

2. Related Art

The development and implementation of a successful strategy is crucial to many activities, such as business, politics, legal proceedings, and even games or sports. In order to develop and implement a successful strategy, it is often necessary to generate a number of strategic options for testing and evaluation. It is likely that many of these strategic options will never actually be implemented. However, to arrive at a successful strategy, it may be desirable to have many and widely ranging options from which to choose.

Many individuals participating in activities requiring the development of strategies frequently do so in ad hoc, out-dated, or inefficient manners. Group brainstorming sessions are one commonly utilized method for developing strategic options. Some individuals do not develop strategic options at all, and simply react to changing circumstances as they occur. One potential disadvantage of conventional methods of developing strategic options is that those methods often lead to narrowly focused strategic option development and do not lead to innovative ideas. Furthermore, these conventional methods often do not provide systematic and organized techniques for sorting strategic options that have been developed, selecting particular strategic options for further analysis, or providing criteria to assist in the implementation of the options that have been developed.

### OBJECTS OF THE INVENTION

The present invention provides a method and computer-based interactive system for facilitating the development of strategic options.

It is an object of an embodiment of the present invention to facilitate the development of strategic options.

It is an object of an embodiment of the present invention to provide a method for facilitating the development of strategic options, in which descriptions of strategic options generated by the user are organized into a list from which one or more strategic options are selected and analyzed using predetermined implementation criteria.

It is an object of an embodiment of the present invention to provide a computer implemented interactive system for facilitating the development of strategic options.

These objects are achieved by some, but not necessarily all, embodiments of the invention. The scope of the claimed invention is as defined in the claims, including all equivalents, and should not be limited by any of the following these objects.

### SUMMARY OF THE INVENTION

One aspect of the present invention provides a method for facilitating the development of strategic options. Information comprising descriptions of strategic options is requested. This information is received, stored, and organized into a list of strategic options. The list of strategic options is displayed, and a particular strategic option is selected. For the selected strategic option, information responsive to predetermined implementation criteria is requested and displayed.

In another aspect of the present invention, a method for facilitating the development of strategic options comprises displaying a list of interactive exercises for developing strategic options. One or more strategic option exercises may be selected from the list and performed. After a strategic option exercise is selected, a prompt associated with the selected strategic option is displayed. The prompt requests information comprising descriptions of strategic options. Information responsive to this prompt is received and organized into a list of strategic options. The list of strategic options and another prompt are displayed, prompting the selection of a strategic option from the list. A particular strategic option is then selected from the list. For the selected strategic option, information responsive to predetermined implementation criteria is requested and displayed.

In yet another aspect of the present invention, a method for facilitating the development of strategic options is provided using a computer-readable medium. The computer-readable medium has executable instructions for performing certain functions. These functions include requesting information regarding descriptions of strategic options; receiving that information; storing that information; organizing the information into a list of strategic options; displaying the list of strategic options; requesting and receiving a selection of a strategic option from the list; and requesting information responsive to predetermined implementation criteria for the selected strategic option.

In another aspect, the present invention provides a computer-implemented system for developing strategic options. The system includes a processor, comprising a memory device that is connected to a display device and an input device. The display device displays a prompt to a user, requesting the user to enter descriptions of strategic options. This input is received by the input device, and is stored by the memory device. The processor organizes the input into a list of strategic options. The display device displays this list to a user, and requests the user to select a particular strategic option. The display device then provides a prompt requesting information regarding the selected strategic option responsive to predetermined implementation criteria.

In another aspect of the present invention, the display device displays an exercise list comprising a listing of a plurality of strategic option exercises. From this list, the user may select one or more exercises. For each selected exercise, the user is prompted to input descriptions of strategic options, which are received, stored, and organized into a list of strategic options. Selected strategic options may then be further developed responsive to predetermined implementation criteria.

### BRIEF DESCRIPTION OF THE FIGURES

FIG. 1 depicts a block diagram of an embodiment of a method for facilitating the development of strategic options according to the present invention.

FIG. 2 depicts an embodiment of an introduction page of a method for facilitating the development of strategic options according to the present invention.

FIG. 3 depicts an embodiment of an example page of a method for facilitating the development of strategic options according to the present invention.

FIG. 4A depicts one embodiment of a prompt/input page of a method for facilitating the development of strategic options according to the present invention.

FIG. 4B depicts the embodiment shown in FIG. 4A, with the trend category list displayed.

FIG. 4C depicts the embodiment shown in FIG. 4A, in which a description of a strategic option has been entered.

FIG. 4D depicts the embodiment shown in FIG. 4A, in which another description of a strategic option has been entered.

FIG. 5 depicts an embodiment of an exercise summary page of a method for facilitating the development of strategic options according to the present invention.

FIG. 6 depicts an embodiment of a strategic option selection page of a method for facilitating the development of strategic options according to the present invention.

FIG. 7 depicts an embodiment of an implementation page of a method for facilitating the development of strategic options according to the present invention.

FIG. 8 depicts a block diagram of another embodiment of a method for facilitating the development of strategic options according to the present invention, in which a plurality of strategic option exercises is presented.

FIG. 9 depicts an embodiment of an exercise menu page of a method for facilitating the development of strategic options according to the present invention.

FIG. 10 depicts a computer system suitable for use with an embodiment of a system for facilitating the development of strategic options according to the present invention.

### DETAILED DESCRIPTION OF THE PREFERRED EMBODIMENTS

Reference will now be made in detail to the preferred embodiments of the invention, examples of which are illustrated in the accompanying drawings. The present invention may be implemented using a computer system using software, hardware or any combination thereof, as would be apparent to those of ordinary skill in the art. The figures and examples identified and described in this specification are not meant to limit the scope of the present invention or its embodiments or equivalents. For the purpose of explanation, numerous specific details, such as certain computer displays, and the like, are set forth. It will be apparent to one skilled in the art that the present invention may be practiced without these specific details and is not limited to the specific details shown and described. In other instances, structures and devices are shown in block diagram form in order to set forth the present invention more clearly.

The present invention provides a system and method for facilitating the development of strategic options. A strategic option, generally, is a plan of action that may be applied in the context of business, politics, games or sports, and the like, to achieve a particular result. In one embodiment, the strategic options are directed to business strategies. For example, in the context of a new chain of retail gasoline outlets, one strategic option may be to construct nearly completely automated stations, with no attendants, no snack-shop, and all transactions by credit card. Another strategic option for this business would be to construct completely full service stations, with gourmet food-shops selling high-end fresh and prepared foods. These specific examples are illustrative only, and the present invention is not limited to strategic options in the business context.

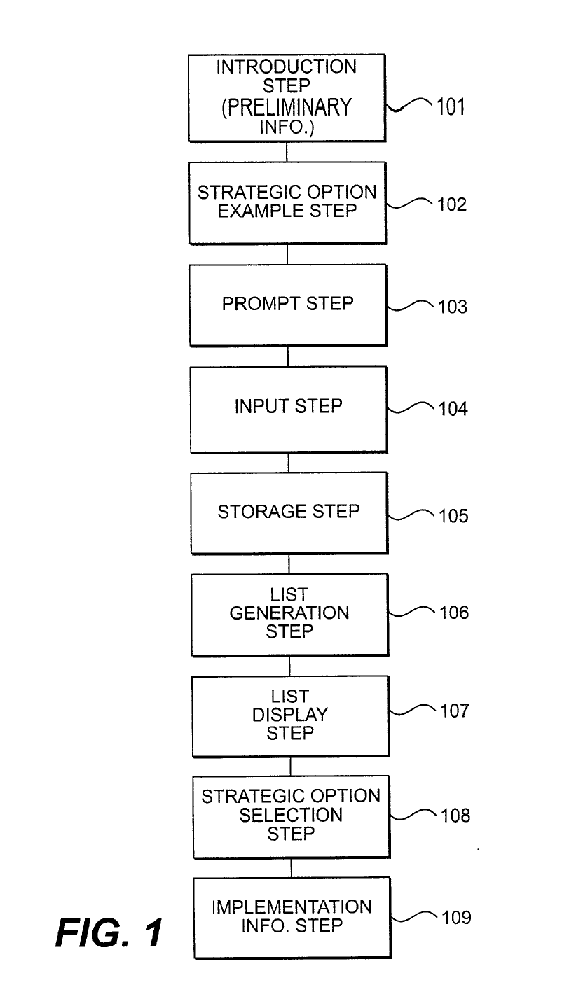

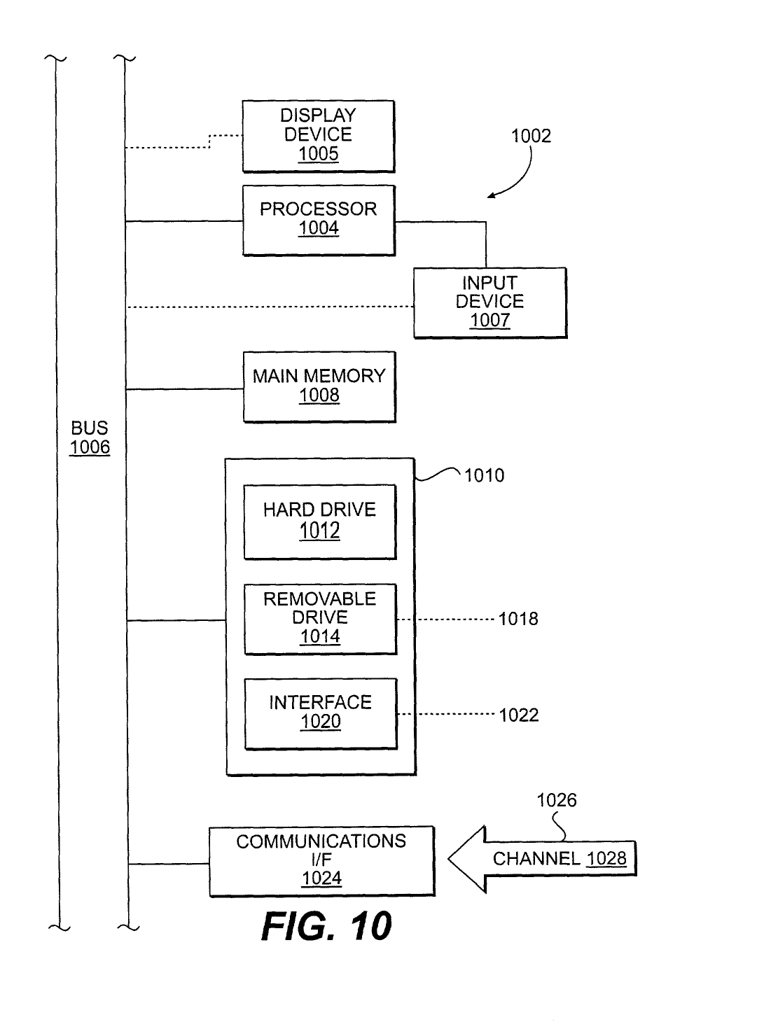

FIG. 1 illustrates an embodiment of a method for facilitating the development of strategic options according to the present invention. In this embodiment, an exercise (also referred to as a strategic option exercise) is conducted to facilitate the development of strategic options. An initial step in such an embodiment is Introduction Step 101, in which introductory or preliminary information is provided to the user. Such preliminary information may include instructions regarding the exercise, an explanation of a particular approach to strategic option generation, or a particular starting point from which the user can base her analysis. In an embodiment in which Introduction Step 101 provides descriptions regarding approaches to strategic option generation, such approaches may include, for example, analyzing internal capabilities of a particular business; analyzing external trends, such as demographic, technological or legal trends; or redefining the goals and measures of success in a particular industry. In one embodiment, the present invention is implemented using a computer system, programmed to perform the steps shown in FIG. 1. In such an embodiment, information provided in Introduction Step 101 may be displayed to the user by means of a display device, such as a computer monitor known in the art. An exemplary computer system suitable for use with an embodiment of the present invention is depicted in FIG. 10 and described below.

In the embodiment shown in FIG. 1, after Introduction Step 101, the user is presented with a strategic option example, in Strategic Option Example Step 102. The strategic option example may be a “real world” and preferably successful application of the exercise described in Introduction Step 101. For example, if a particular approach to strategic option development is described in Introduction Step 101, the strategic option example is preferably an exemplary strategy applying that approach to strategic option development. For example, Introduction Step 101 may comprise a description of an approach to strategic option development in which the metrics for determining success in an industry are altered. In such an example embodiment, Strategic Option Example Step 102 may comprise an example from the insurance industry, where some companies have improved their profit margins by defining profitability at the household level, rather than the individual policy level. By presenting the user with such an example, the approach to strategic option development described in Introduction Step 101 is further explained in more tangible terms. This may provide additional motivation for the user to generate her own strategic options. As would be understood by one skilled in the art, numerous examples may be provided for review by the user.

In another embodiment, the examples presented as part of Strategic Example Step 102 may be displayed to the user by means of a computer display device, such as a monitor, as described in connection with Introduction Step 101.

In the embodiment shown in FIG. 1, the next step is Prompt Step 103, in which the user is prompted to develop strategic options. Preferably, the user is prompted to develop strategic options in response to the information provided in Introduction Step 101, such as an approach to strategic option development, and the example strategy provided in Strategic Option Example Step 102. In Prompt Step 103, the user may be provided with a prompt that includes an additional description of the approach to strategic option generation, or one or more examples illustrating the approach, or both. Once again, when the present invention is implemented using a computer system, the prompt may be displayed by means of a computer monitor or other display device.

In the embodiment depicted in FIG. 1, the next step is Input Step 104, in which a user provides input in the form of descriptions of the strategic options that she has generated in response to Prompt Step 103. In some embodiments of Input Step 104, the user is permitted to enter multiple responses to the prompt. In a computer-implemented environment, this input may be provided by means of a computer keyboard, mouse, or other input device, as known in the art.

In the embodiment shown in FIG. 1, the next step is Storage Step 105, in which the descriptions of strategic options entered by the user in Input Step 104 are stored. As known in the art, if Storage Step 105 is implemented in a computer system, the storage may be on a hard disk, a floppy disk or other storage device or medium.

After input is stored in Storage Step 105, the next step of the embodiment shown in FIG. 1 is List Generation Step 106, in which the stored input is organized and a list of the input strategic options is generated. In a computer-implemented environment, List Generation Step 106 is accomplished by a processor or other component or system as known in the art. This list may be organized based on the order in which the input was entered, it may be organized alphabetically, it may be organized based on prioritization provided by the user, or in any number of additional ways as would be appreciated by one skilled in the art.

After the list is generated, the next step of the embodiment shown in FIG. 1 is List Display Step 107, in which the list generated in List Generation Step 106 is displayed to the user. This display may occur using a computer display device, such as a monitor.

After List Display Step 107, the next step in the embodiment shown in FIG. 1 is Strategic Option Selection Step 108, in which the user selects one or more of the strategic options that are included in the list.

After the user has selected a strategic option, the next step in the embodiment shown in FIG. 1 is Implementation Information Step 109. In Implementation Information Step 109, the user is prompted to enter information responsive to predetermined implementation criteria. The implementation criteria preferably direct the user to begin the process of transforming the strategic option into a strategy that may be implemented in a context relevant to the user. Preferably, the implementation criteria relate to issues relevant to the development and implementation of the strategic option in a context relevant to the user. In a business context, for example, the predetermined implementation criteria may include, but are not limited to, inquiries regarding the potential market for the strategic option, any competitive advantage the strategic option may enjoy, and the economic model the strategic option may utilize. Additionally, the user may be asked to provide the strategic option with a compelling name, to provide additional description of the strategic option, and to provide a description of a value proposition to a customer. Various other implementation criteria may be presented to the user, as appropriate in the context in which the present invention is utilized.

An illustration of an embodiment of a method for facilitating the development of strategic options will be described in detail. In this embodiment, the method of the present invention is implemented using a programmed computer, which presents a strategic option exercise to the user. As would be readily apparent to one skilled in the art, the visual displays and screen layouts shown in the figures are illustrative in nature, and could be implemented in a variety of ways. The present invention is not limited to any particular display or screen layout.

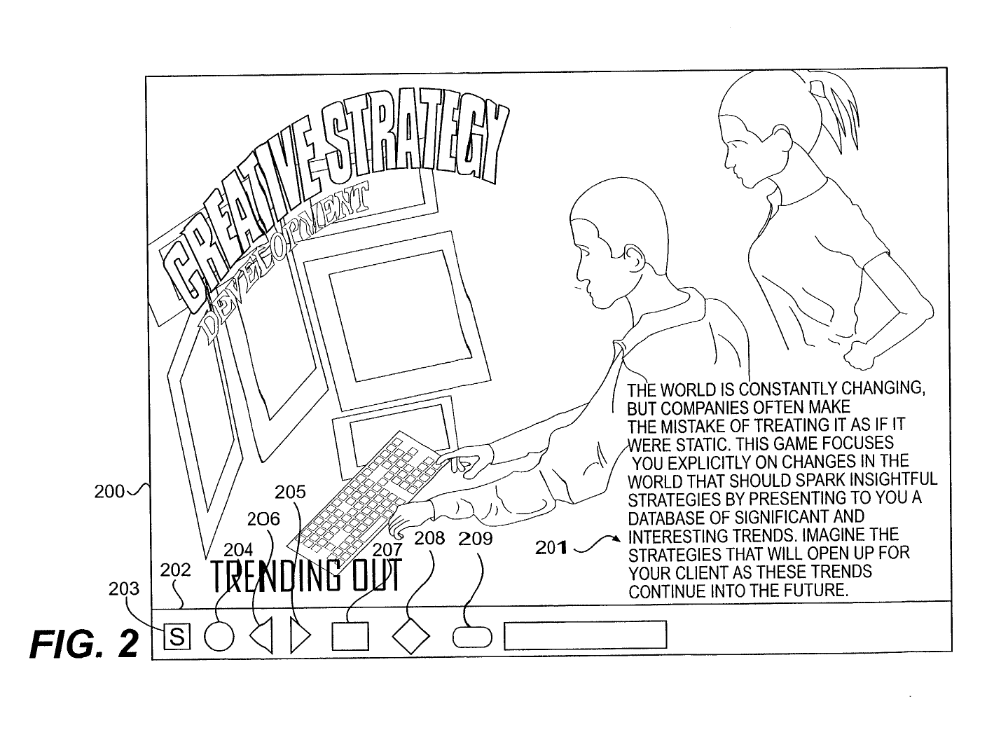

This embodiment begins with introduction page 200, shown at FIG. 2. Consistent with Introduction Step 101 shown in FIG. 1 and described above, introduction page 200 contains an exercise explanation 201. Exercise explanation 201 provides pre-determined initial instructions regarding the exercise and relevant background information to allow a user to perform the method of the invention embodied in the particular exercise. This particular exercise of this example deals with trends of various types, and ways in which business strategies can be developed to capitalize on those trends. This basic premise is explained in exercise explanation 201, so that the user is apprised of the basic aspects of the exercise before participating in the remainder of the exercise.

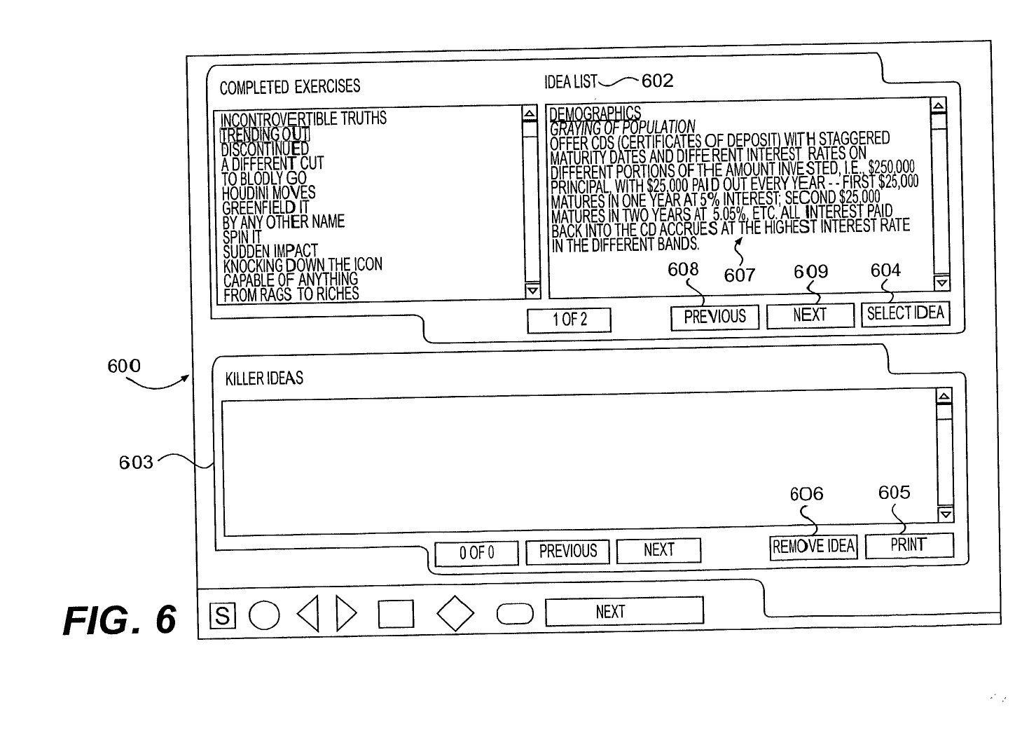

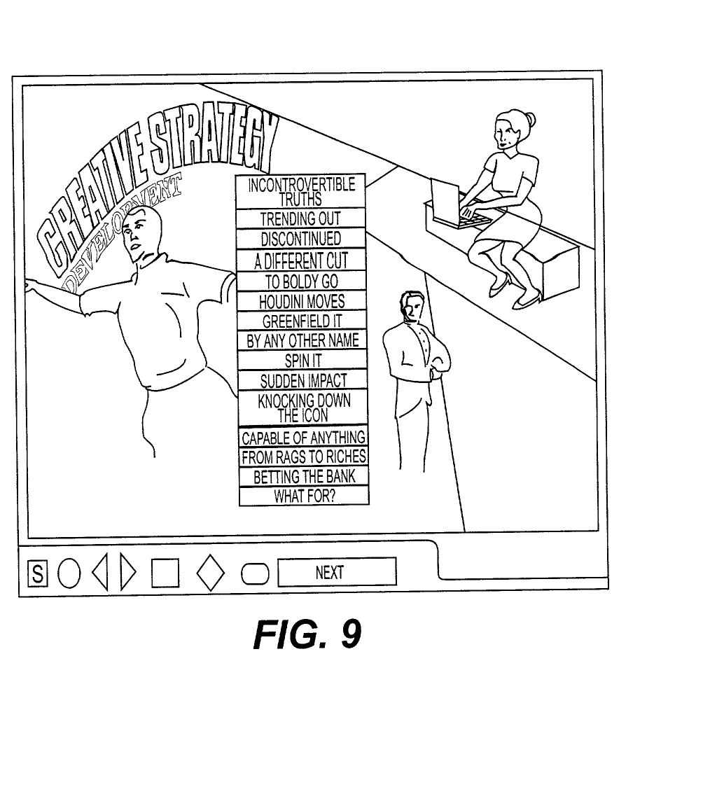

In addition, continuing with the illustration and embodiment, introduction page 200 preferably displays tool bar 202. Tool bar 202 includes buttons that provide the user with certain functions that may be useful during the user's participation in the exercise using techniques that are well known in the art. Save button 203 allows the user to save the progress that she has made and the strategic options that have been generated while performing a particular exercise. Exercise menu button 204 allows the user to navigate to an exercise menu page, shown for example in FIG. 9. Such an exercise menu page is particularly useful when the present invention is implemented using a number of strategic option exercises, as described below. Forward button 205 and backward button 206 allow the user to navigate to the next and previous pages, respectively. Strategic option selection page button 207 allows the user to navigate to strategic option selection page 600, shown in FIG. 6. Help button 208 allows the user to access additional instructions about performing the exercise. Exit button 209 allows the user to exit the exercise, in a manner known in the art. Preferably, the other pages of this strategic option exercise contain a similar tool bar.

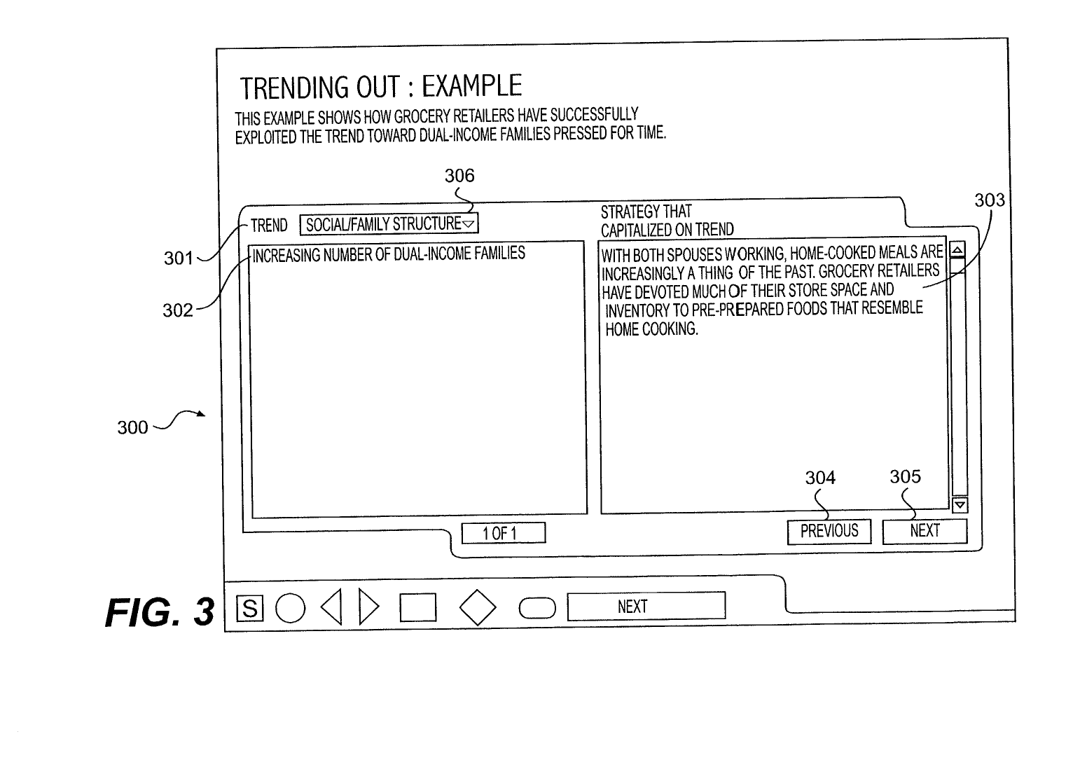

Continuing with the embodiment and illustration described with respect to FIG. 2, the next page displayed to the user may be example page 300, shown in FIG. 3. Example page 300 corresponds to Strategic Option Example Step 102, shown in FIG. 1 and described above. In this particular embodiment and illustration, example page 300 includes a predetermined example trend category 301, and a predetermined example trend 302. Example trend category 301 is “Social/family structure” and example trend 302 is the “Increasing number of dual-income families.” Additionally, a predetermined example strategy 303 that capitalizes on example trend 302 is provided. Trend categories 301 and trends 302 may be derived in any number of ways as would be apparent to one skilled in the art. For example, if the present invention were implemented in the business context, research could be done to identify important trends facing various industries. Those trends could then be organized into trend categories in a manner known in the art. Similarly, example strategies 303 capitalizing on various trends could be derived empirically based on research regarding successful businesses in numerous industries. Other ways to develop such example strategies are known in the art.

In this particular illustration, the example strategy identifies a particular industry (grocery retailers) and the strategy developed by members of that industry in response to the identified trend (devoting more store space to pre-prepared foods). Preferably, several example trend categories 301, trends 302, and strategies 303 responsive to the trends are provided. The user may select additional trend categories by using a mouse to select down arrow 306, or by using other techniques known in the art. The user may view different trends 302 and strategies 303 responsive to those trends by using previous button 304 and next button 305.

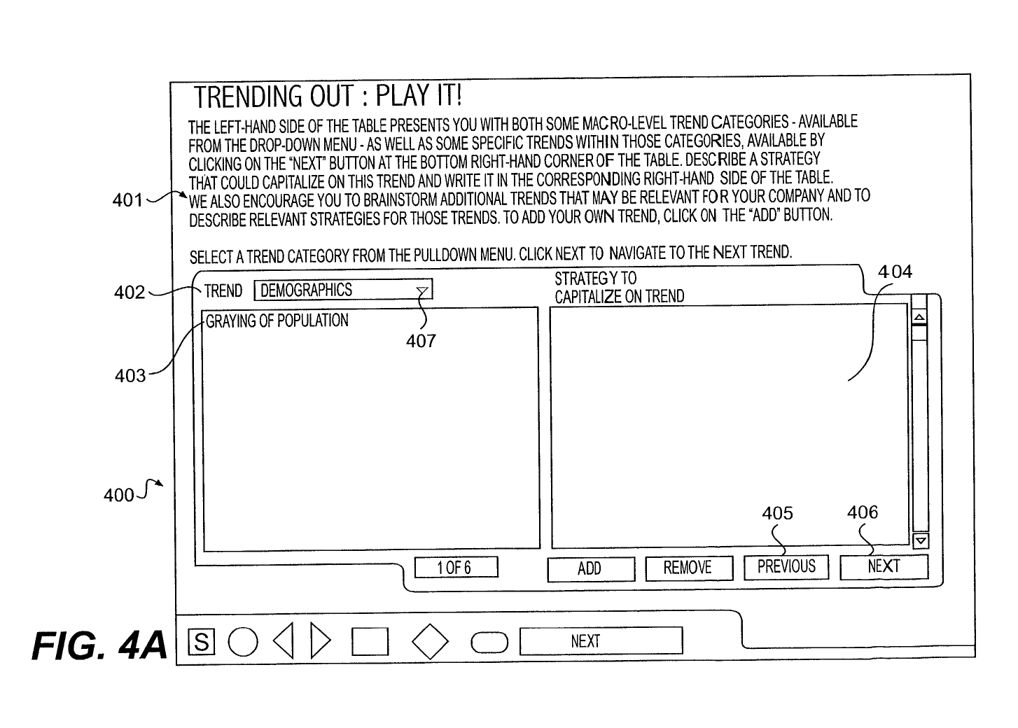

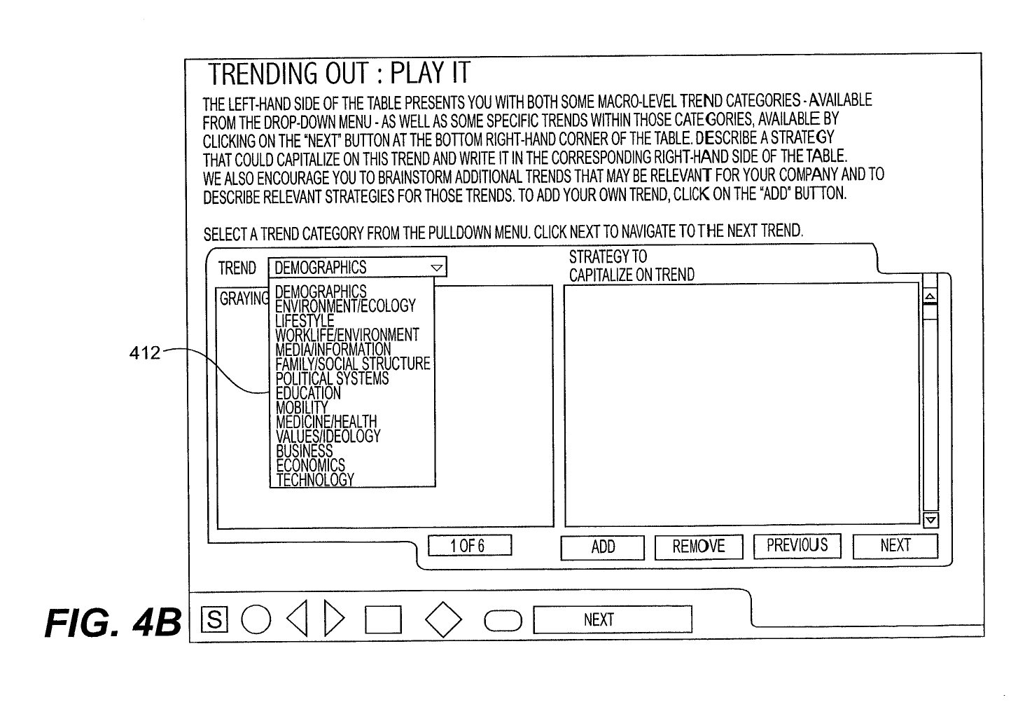

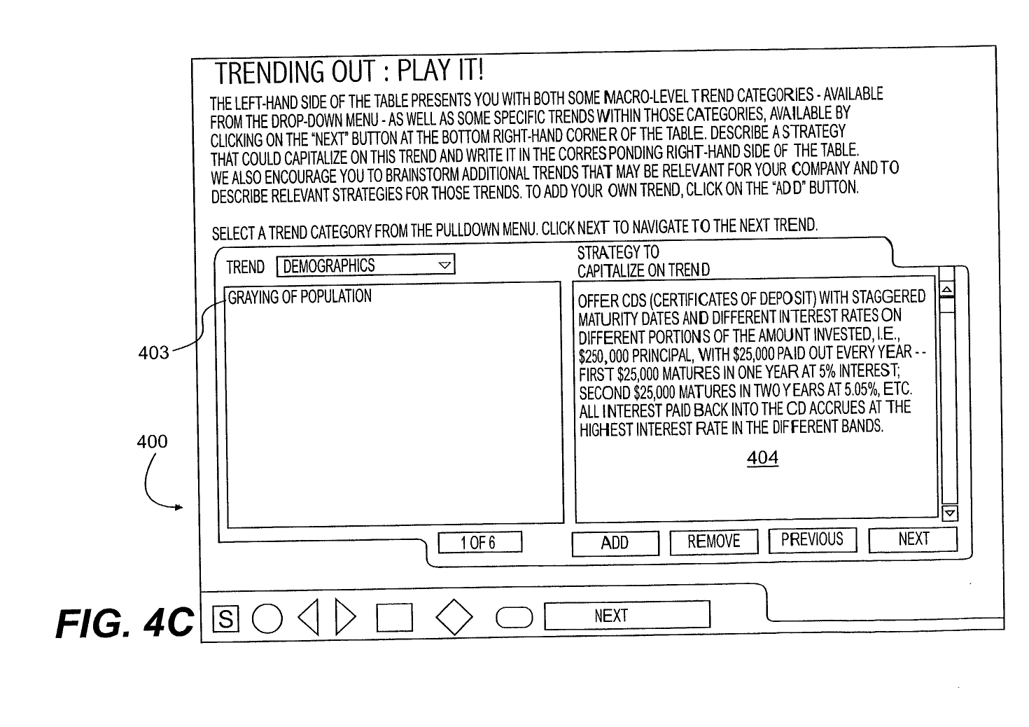

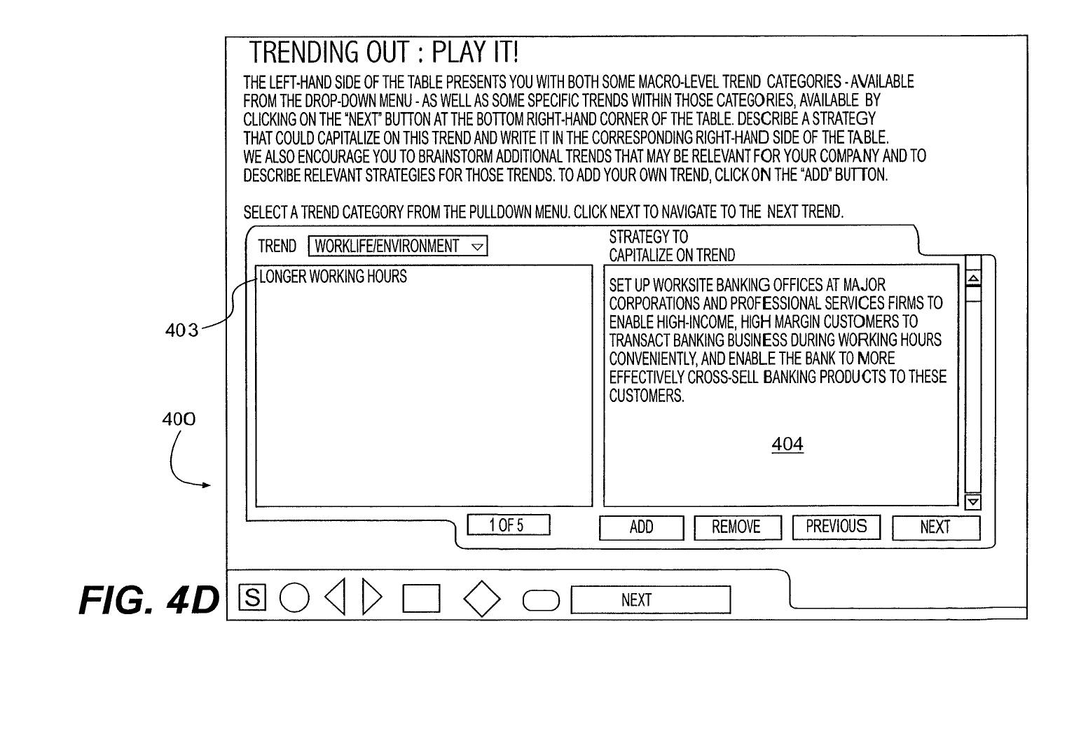

After the user views example page 300, the next page in this embodiment and illustration is prompt/input page 400, shown in FIG. 4A. Prompt/input page 400 includes prompt 401, which invites the user enter input describing strategic options responsive to a particular trend, similar to Prompt Step 103, described above. Preferably, numerous trends are provided, and the user may select some or all of these numerous trends. A user selects a particular trend by first identifying a trend category 402, such as by using a mouse to “click on” down arrow 407. A plurality of trend categories may be provided, as shown in FIG. 4B. Thus, a user may select any one of number of trend categories, including, but not limited to, demographics, environment/ecology, and lifestyle. Each trend category 402 preferably contains one or more trends 403. Consistent with Input Step 104 described above, the user may then input descriptions of strategic options that capitalize on the various trends into box 404. This input may occur using a computer keyboard, mouse, or other input device, as known in the art. The user may enter multiple strategies into box 404. Additionally, the user may navigate among the trends within each trend category by using previous button 405 and next button 406. Further, the user may select other trend categories by using pull down menu 412, shown in FIG. 4B.

FIGS. 4C and 4D illustrate prompt/input pages 400 in which descriptions of strategic options that capitalize on different trends 403 have been entered into box 404.

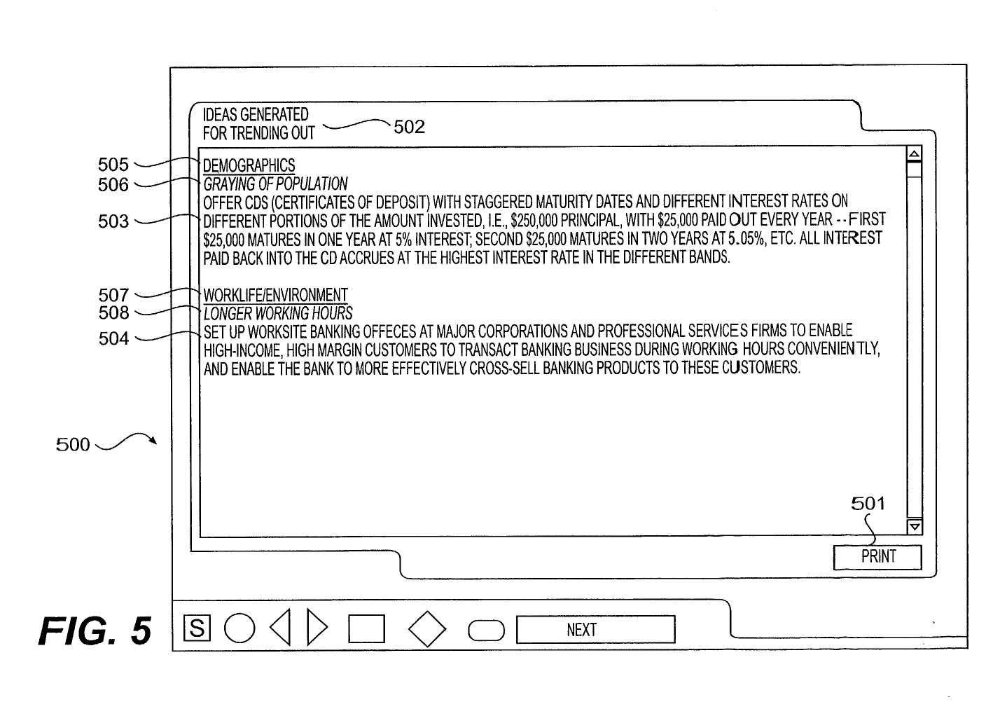

Continuing with the description of this illustrative embodiment, exercise summary page 500 is shown in FIG. 5. In exercise summary page 500, the strategic options generated by the user while performing the exercise are organized and displayed for review by the user, as described above in connection with List Generation Step 106 and List Display Step 107 (FIG. 1). Generated strategic option list 502 is displayed to the user and includes strategic option descriptions 503 and 504, as entered into box 404 (FIGS. 4C-D). Listed along with strategic option description 503 are trend category 505 and trend 506 associated with strategic option description 503. Similarly, strategic option description 504 is listed along with trend category 507 and trend 508. This listing may be printed using print button 501, in a manner well-known in the art.

After exercise summary page 500 is displayed to the user, the next page in this illustration and embodiment is strategic option selection page 600, shown in FIG. 6. In strategic option selection page 600, strategic option list 602 is displayed to the user which contains a strategic option description 607. Additional strategic option descriptions may be viewed by using previous button 608 and next button 609. Consistent with Strategic Option Selection Step 108, the user is prompted to identify one or more strategic options and select them for additional analysis, using select button 604. In this particular illustration, these selected strategic options are then listed in “killer ideas” box 603. The strategic options in “killer ideas” box 603 may be printed using print button 605. Additionally, strategic options may be removed from “killer ideas” box 603 using remove button 606.

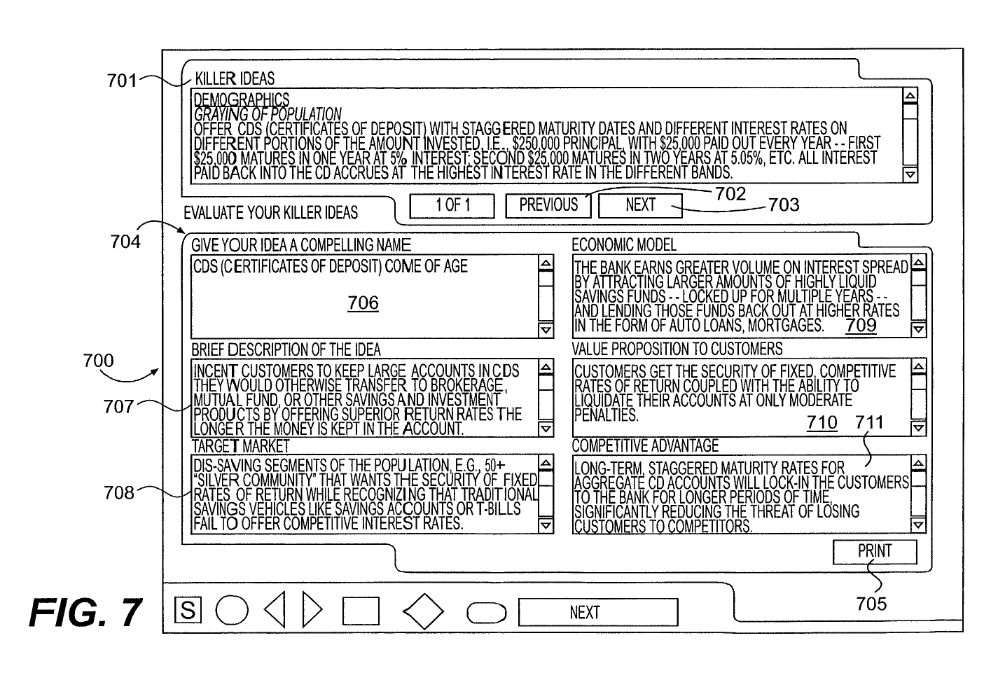

After the user has selected one or more strategic options for further analysis, the next page in this illustration and embodiment is implementation page 700, shown in FIG. 7. Implementation page 700 includes box 701, where one of the strategic options selected as a “killer idea” is displayed. If the user has selected additional strategic options as “killer ideas,” these may be displayed by using previous button 702 and next button 703. A selected strategic option may be analyzed using a series of predetermined implementation criteria 704. In this illustration and embodiment these criteria may include, but are not limited to, a target market for the strategic option, an economic model associated with the strategic option, and any competitive advantage that the strategic option could have. In response to these implementation criteria, the user may provide information regarding the implementation of each selected strategic option. This information may be provided in boxes 706-711. This information may be printed using button 705.

Additional embodiments of methods for facilitating the development of strategic options according to the present invention will now be described. Once again, the particular embodiments described herein are examples only, and the present invention is not limited to these particular embodiments.

An additional embodiment of a method for facilitating the development of strategic options according to the present invention deals with challenging widely held beliefs in an industry. In this embodiment, an introduction page similar to that shown in FIG. 2, and described with respect to Introduction Step 101 (FIG. 1), may be displayed to the user. The user is presented with an exercise explanation relevant to the basic premise of challenging widely held beliefs. After the introduction, the next step in the method is the presentation of an example page, similar to that shown in FIG. 3, and to that described with respect to Strategic Option Example Step 102 (FIG. 1). In the example page, particular examples are provided of beliefs that were widely held in an industry, and an example of a strategy that successfully challenged that belief. For instance, a belief once widely held among brokerage houses was that maximum profitability would be derived from large commission fess. An example of a strategy that successfully challenged that belief is the recent success of discount brokerage houses that have far lower fees but higher volumes than traditional brokerage houses. As another example, the belief that retail chains could not be profitable in rural areas was successfully challenged by companies such as Wal-Mart. After the example page, the user may proceed to a prompt/input page, similar to that shown in FIG. 4A and to that described with respect to Prompt Step 103 and Input Step 104 (FIG. 1). There, the user is prompted to enter widely held beliefs that are found in her industry, and to generate strategic options that challenge those beliefs. The strategic options that are generated may be stored and organized into a strategic option list in a manner similar to that depicted in FIG. 5 and that described with respect to Storage Step 105, List Generation Step 106, and List Storage Step 107 (FIG. 1). Particular strategic options may be selected and then analyzed in response to predetermined implementation criteria, in a manner similar to that shown in FIGS. 6 and 7, and to that described with respect to Selection Step 108 and Implementation Information Step 109.

Another embodiment of the present invention deals with discontinuities that may be relevant to a business. Discontinuities are commonly considered to be redirections or shifts in consumer attitudes, regulations, competitive behavior, technology, and the like. Thus, in an illustration of this embodiment, an introduction page may explain the concept of discontinuities, and use of discontinuities to develop business strategies. After the introduction page, the user is presented with an example page. The example page reveals examples of businesses that have successfully used discontinuities to develop strategies, such as, in the consumer attitudes area, companies that have successfully responded to European rejection of genetically modified (“GM”) foods by marketing their foods as GM free; in the regulation area, discount brokers that emerged after minimum fee restrictions were lifted; in the competitive behavior area, Wal-Mart's entry into the European market spawned numerous mergers of retail stores in Europe; and in the technology area, Internet enabled shopping that led to the creation of businesses such as Amazon.com. After the example page, the user is presented with a prompt/input page, where the user is prompted to identify discontinuities in her business, and to develop strategies based on these discontinuities.

Another embodiment deals with metrics by which the success of a business is measured. Strategic options may be generated by altering these metrics. In this embodiment, the introduction page could explain this basic approach. After the introduction page, the user is presented with an example page, providing examples of businesses that changed the traditional metric by which success was measured in their industry to successfully develop new strategies. Thus, the example page could identify companies such as Gillette, which measured success by its share of the men's shaver market, and was able to develop strategies by defining its success by its share of the entire home grooming market. The user is then prompted to identify alternative metrics in her business and to use this as a basis for developing strategic options.

Another embodiment deals with the conventionally recognized limits in a particular industry and the possibility of exceeding those limits to develop successful business strategies. In this embodiment, the introduction page may explain this basic approach to strategic option development. After the introduction page, the user is presented with an example page describing examples of businesses that have successfully developed strategies that have exceeded boundaries in their industries. Examples presented could include Wal-Mart, which exceeded boundaries by going after rural customers that other retail chains ignored, or certain brokerage houses, which targeted individual, not institutional, investors with great success. The user is then prompted to identify traditional boundaries relevant to her business and then develop strategic options that could or would exceed those boundaries. A similar embodiment takes as its starting point the constraints on businesses. Examples are provided to the user of businesses that have been faced with constraints and developed strategies that have circumvented or surmounted these constraints. The user is then prompted to identify constraints on her business and to develop strategic options that circumvent or surmount these constraints.

Another embodiment of the present invention takes as its starting point perceptions that individuals have about their business. Thus, the user could be presented with an introduction page which may describe the effect of perceived limitations on the scope of a business. Examples may then be provided of businesses that have achieved success by changing the perceived limitation on the scope of their business, including, for example, a car manufacturer that could broadly define its business as “transportation business” and provide commuter van service or could also define its business as the “engineering business,” and provide outside engineering consulting services. The user is then prompted broadly to define the scope of her business and to develop strategic options that are in accord the business as thus broadly defined.

Another embodiment of the present invention takes as its staring point the real or perceived limits that are placed on business by legacies, such as inherited assets, organizational structure, a balance sheet, a business system configuration, and so on. Thus, the user could be presented with an introduction page which may describe the effect that these limits have on the ability to developed creative strategic options. Examples may then be provided of businesses that have achieved success by casting off some of these legacies and developing strategic options as if they were newly formed companies. Presented examples could include movie theatre chains that have revamped old theatres to provide stadium seating and enhanced sound. The user is then prompted to develop strategic options by attempting to identify a preferred aspect of a business without concern for legacies, and applying that to her own business.

Another embodiment of the present invention takes as its starting point emerging developments that could render certain businesses obsolete. Thus, the user could be presented with an introduction screen that may describe the possibility of such emerging developments, and how businesses should be reacting to such developments. Examples may then be provided of businesses that have been faced with such emerging developments and have successfully reacted to them, such as how manufacturers of standard cameras could respond to the introduction of digital image technology by moving into the digital camera market or by focusing on high-end photography. The user is then prompted to identify such emerging developments that may affect her business and to develop strategic options to address those developments.

Another embodiment of the present invention takes as its starting point successful businesses in a variety of industries. By attempting to identify a generic (non-industry specific) strategy associated with these successful companies, an analogous strategy can be developed in a number of different industries. Thus, examples could be provided of companies that have developed successful strategies by using analogies from other industries. For example, one generic strategy could be “Customer Lock-in” and an example of a business successfully taking advantage of this strategy could be the airline industry's use of frequent flier programs. Another generic business strategy could be customization, and an example could be a shoe manufacturer's web-site that allows customers to design their own shoes, which the manufacturer will then produce and ship to the customer. The user is then prompted to develop strategic options applicable to her business by using analogies from successful businesses in other industries.

A similar embodiment of the present invention examines successful or popular businesses and seeks to develop strategies by identifying weaknesses in those businesses. Examples are provided of companies that have found success by identifying weaknesses in the leaders of their particular industry. Thus, Amazon's business model, complete integration and breadth of products, may be a weakness. Simpler business models that could be more quickly implemented, such as bol.com, have successful in emerging markets. The user is then prompted to identify the leaders in her industry and to develop strategic options that capitalize on the weaknesses of those leaders.

Another embodiment of the present invention takes as its starting point the internal capabilities of a business. Examples are provided of businesses that have successfully leveraged core capabilities in innovative ways, including, for example, a print media company that leveraged its distribution capability to assist Internet businesses in distributing products or its graphic design and content creation capabilities to create an Internet site. The user is prompted to identify core capabilities of her business, and to generate strategic options in which those capabilities could be more effectively leveraged.

A further embodiment of the present invention takes the approach of identifying extreme implementations of a particular business. In one illustration of this embodiment, the most economized approach (lowest cost/lowest service) is compared to the premium approach (highest cost/highest level of service). The user is provided with examples of businesses that have been successful by implementing one or the other of these approaches. A presented example could include a new chain of retail gasoline outlets, that have constructed nearly completely automated stations, with no attendants, no snack-shop, and all transactions by credit card or have transitioned to completely full service stations, with gourmet food-shops selling high-end fresh and prepared foods. The user is then prompted to develop strategic options by identifying the most economized and the most premium approach to her business. Other extreme approaches, such as inventory or personnel practices, could be utilized in other illustrations of this embodiment of the present invention.

Another embodiment of the present invention takes as it starting point the risk-averse nature of many companies. The user is presented with examples of companies that have taken large risks that have been successful, such as a company considering a joint venture to acquire some technology that could simply buy the other company outright or a company considering a new product launch that could begin an all-out marketing blitz. The user is then prompted to identify highly risky strategic options that are relevant to her business.

Another embodiment of the present invention takes as its starting point an analysis of the actual use of popular products. Examples are provided of popular products and how they are used by consumers. Further, examples are provided of alternative products that could be just as popular but more effective. Presented examples could include home PC's used to send and receive e-mail and an alternative product that only has the capability to send and receive e-mail. The user is then prompted to identify a current popular product, its use, and a possible alternative product that could provide that utility more effectively.

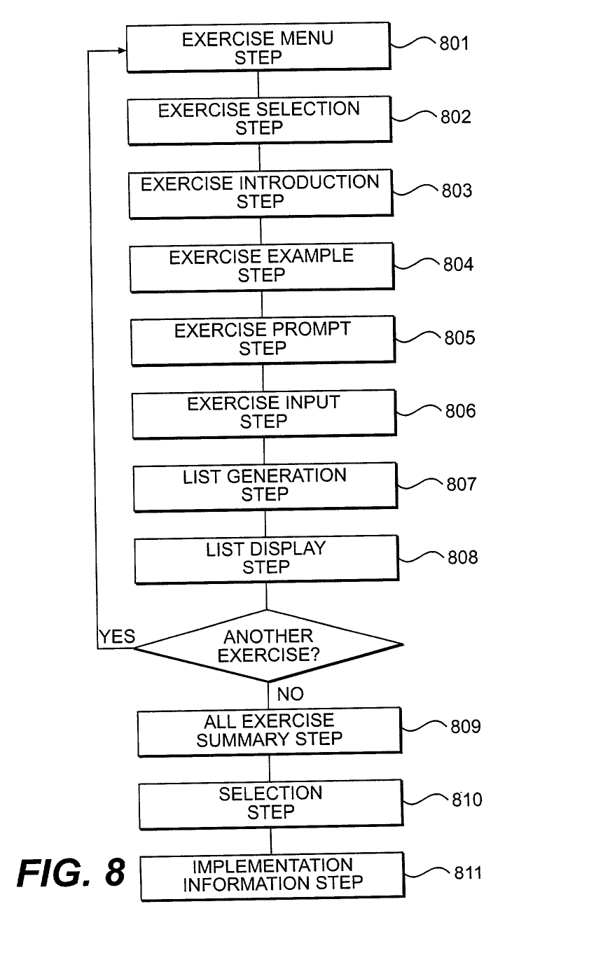

In another embodiment of the present invention, a plurality of different strategic option exercises, such as those described above, is presented to the user. A user may perform one or more of the strategic option exercises to develop strategic options. A flow diagram of such an embodiment may be found in FIG. 8.

In the first step in this embodiment of the present invention, Exercise Menu Step 801, an exercise menu is displayed to the user. An exemplary exercise menu may be found in FIG. 9. This exercise menu may contain a list or menu of strategic option exercises, from which a user can select a particular strategic option exercise to perform. The next step in this embodiment is Exercise Selection Step 802, in which the user selects a particular strategic option exercise to perform. Once the user selects a particular strategic option exercise, that exercise may be performed in a manner consistent with the flow chart depicted in FIG. 1. Thus, the next step in the process is Exercise Introduction Step 803, in which introductory information regarding the selected exercise is displayed. Following Exercise Introduction Step 803, the user is presented with an example of the selected exercise in Exercise Example Step 804. Exercise Example Step 804 provides an example of a strategy that has been or may be developed that is responsive to the selected exercise.

In this embodiment, Exercise Prompt Step 805 follows Exercise Example Step 804. In Exercise Prompt Step 805, the user is prompted to generate descriptions of strategic options that are responsive to the particular exercise. In the next step, Exercise Input Step 806, the user inputs these strategic option descriptions. These descriptions are organized into a summary list of strategic options in List Generation Step 807, and displayed to the user, in List Display Step 808. This list may contain all of the strategic options generated by the user while performing the particular strategic option exercise.

At this point in this embodiment, the user has the option of returning to Exercise Menu Step 801, and repeating the above described steps with respect to another exercise. Alternatively, the user may continue to All Exercise Summary Step 809. In All Exercise Summary Step 809, a listing of all strategic options generated by the user while playing all of the strategic option exercises is displayed to the user. Thus, the user may review options generated using various approaches to the issue of developing strategic options. From this listing, the user may select one or more strategic options, in Selection Step 810. These selected strategic options may then be analyzed and developed in response predetermined implementation criteria, in Implementation Information Step 811.

With reference now to FIG. 10, a description is provided of a computer system suitable for use with and to implement an embodiment of the present invention. The computer system 1002 includes one or more processors, such as a processor 1004. Processor 1004 is connected to a communication bus 1006. Additionally, processor 1004 is connected to a display device 1005, such as a conventional computer monitor, and an input device 1007, such as a keyboard or mouse. Alternatively, display device 1005 and input device 1007 may be connected to communication bus 1006. Furthermore, numerous display devices (not shown) may be connected to either processor 1004 or communication bus 1006. A person skilled in the relevant art will also appreciate how to implement the invention and various embodiments using other computer systems and/or computer architectures.

The computer system 1002 also includes a main memory 1008, preferably random access memory (RAM), and can also include a secondary memory 1010, which in turn can include, for example, a hard disk drive 1012 and/or a removable storage drive 1014, representing a floppy disk drive, a magnetic tape drive, an optical disk drive, or other like device. Removable storage drive 1014 reads from and/or writes to a removable storage unit 1018 in a well-known manner. Removable storage unit 1018, represents a floppy disk, magnetic tape, optical disk, or other like device, which is read by and written to by removable storage drive 1014. As will be appreciated by one skilled in the art, removable storage unit 1018 includes a computer usable storage medium having stored therein computer software and/or data.

In other embodiments, secondary memory 1010 may include other similar means for allowing computer programs or other instructions to be loaded into computer system 1002. Such means can include, for example, a removable storage unit 1022 and an interface 1020. Other examples can include a program cartridge and cartridge interface (such as that found in video game devices), a removable memory chip (such as an EPROM, or PROM) and associated socket, and other removable storage units 1022 and interfaces 1020 which allow software and data to be transferred from removable storage unit 1022 to computer system 1002.

In the embodiment depicted in FIG. 10, computer system 1002 can also include a communications interface 1024, which allows software and data to be transferred between computer system 1002 and external devices. Examples of communications interface 1024 include a modem, a network interface (such as an Ethernet card), a communications port, a PCMCIA slot and card, and other devices and circuits known in the art. Software and data transferred via communications interface 1024 include signals 1026 that may be electronic, electromagnetic, optical or other signals capable of being received by the communications interface 1024. Signals 1026 are provided to communications interface 1028, for example. Channel 1028 carries signals 1026 and can be implemented using wire or cable, fiber optics, a phone line, a cellular phone link, an RF link and other communications media and technologies as known in the art.

In this specification, the terms “computer program medium,” “computer usable medium” and “computer readable medium” are used generally to refer to media such as removable storage device 1018, a hard disk installed in hard disk drive 1012, or signals 1026, used or useful with computers and computer devices, as known in the art, for providing software to computer system 1002.

Computer programs (also called computer control logic) are stored in main memory 1008 or secondary memory 1010, or both. Computer programs can also be received at the communications interface 1024. Such computer programs, when executed, enable computer system 1002 to implement and embody the present invention. Accordingly, such computer programs represent controllers of the computer system 1002.

In an embodiment where the invention is implemented by a computer system, for example as depicted for example in FIG. 10, using software, the software may be stored in a computer program product and loaded into computer system 1002 using the removable storage drive 1014, the hard drive 1012 or the communications interface 1024. The control logic (software), when executed by processor 1004, causes the computer system to operate in accordance with the present invention. In one embodiment, the control logic initially causes processor 1004 to direct display device 1005 to display an introduction page, such as that shown in FIG. 2, followed by an example page, such as that shown in FIG. 3. Processor 1004 may then cause display device 1005 to display a prompt/input page, such as that shown in FIG. 4A, in which a user is prompted to enter descriptions of strategic options. The user may then provide input to the system by using input device 1007. Input may be stored using main memory 1008 or secondary memory 1010. After the input is received and stored, processor 1004 may then organize the input into a list of strategic options, cause the display device 1005 to display the list and prompt the user to select a strategic option from the list. An example of such a display and prompt is shown in FIGS. 5 and 6. After the user selects a strategic option, the processor causes the display device to display an implementation information page, such as that shown in FIG. 7, where the user is prompted to input information regarding the implementation of the selected strategic option.

In an embodiment in which numerous display devices are connected to processor 1004 or communication bus 1006, the processor 1004 may direct that different pages are displayed on one or more of the different display devices. For example, the prompt/input page may be displayed on one display device, the list of strategic options may be displayed on another display device, and so on.

In another embodiment, the invention is implemented primarily in computer hardware using, for example, hardware components such as application specific integrated circuits (ASICs). Implementation of such a hardware state machine so as to perform the functions described above will be apparent to persons skilled in the art In other embodiments, the invention may be implemented using a combination of both hardware and software, as known in the art.

Although particular embodiments of the invention have been described and illustrated, it is recognized that modifications and variations may readily occur to those skilled in the art, and consequently it is intended that the claims be interpreted to cover such modifications and equivalents.

1. A system for facilitating the development of strategic options comprising:
a processor, comprising a memory device, connected to a display device and an input device, wherein
the display device displays a request-prompt requesting information comprising descriptions of strategic options;
the input device receives information responsive to the request-prompt;
the memory device stores the information received by the input device;
the processor organizes the information into a list of strategic options;
the display device displays the list and a selection-prompt requesting a selection of a strategic option;
the input device receives the selection; and
the display device displays an implementation-prompt requesting, for the selected strategic option, information responsive to predetermined implementation criteria.

2. The system of claim 1, wherein the request-prompt comprises a description of an approach to strategic option development.

3. The system of claim 2, wherein the request-prompt further comprises an example strategy exemplifying the approach to strategic option development.

4. The system of claim 1, wherein the request-prompt comprises a description of a trend.

5. The system of claim 4, wherein the request-prompt further comprises an example strategy responsive to the trend.

6. A system for facilitating the development of strategic options comprising:
a processor, comprising a memory device, connected to a display device and an input device, wherein
the display device displays an exercise list identifying a plurality of strategic option exercises and solicits a selection of a strategic option exercise;
the input device receives the selection of the strategic option exercise;
the display device displays a request-prompt associated with the selected strategic option exercise, wherein the request-prompt requests information comprising descriptions of strategic options;
the input device receives information responsive to the request-prompt;
the memory device stores the information responsive to the request-prompt received by the input device;
the processor organizes the information responsive to the request-prompt into a list of strategic options;
the display device displays the list of strategic options and a selection-prompt requesting a selection of a strategic option;
the input device receives the selection of the strategic option; and
the display device displays an implementation-prompt requesting, for the selected strategic option, information responsive to predetermined implementation criteria.

7. The system of claim 6, wherein the request-prompt comprises a description of an approach to strategic option development.

8. The system of claim 7, wherein the request-prompt further comprises an example strategy exemplifying the approach to strategic option development.

9. The system of claim 6, wherein the request-prompt comprises a description of a trend.

10. The system of claim 9, wherein the request-prompt further comprises an example strategy responsive to the trend.

11. The system of claim 6, wherein
the display device solicits the selection of a second strategic option exercise;
the input device receives the selection of the second strategic option exercise;
the display device displays a second request-prompt associated with the selected second strategic option exercise, wherein the second request-prompt requests information comprising descriptions of strategic options;
the input device receives information responsive to the second request-prompt;
the memory device stores the information responsive to the second request-prompt received by the input device; and
the processor organizes the information responsive to the second request-prompt into the list of strategic options.

12. A system for facilitating the development of strategic options comprising:
first display means for displaying a request-prompt, wherein the request-prompt requests information comprising descriptions of strategic options;
receiving means, coupled to the first display means, for receiving information responsive to the request-prompt;
storing means, coupled to the receiving means, for storing the information received by the receiving means;
processor means, coupled to the storing means, for generating a strategic option list organizing the stored descriptions of the strategic options;
second display means, coupled to the storing means, for displaying the strategic option list;
selection means, coupled to the second display means, for selecting a strategic option from the strategic option list; and
third display means, coupled to the selection means, for displaying an implementation-prompt, wherein the implementation-prompt requests, for the selected strategic option, information responsive to predetermined implementation criteria.

13. The system of claim 12, wherein the request-prompt comprises a description of an approach to strategic option development.

14. The system of claim 13, wherein the request-prompt further comprises an example strategy exemplifying the approach to strategic option development.

15. The system of claim 12, wherein the request-prompt comprises a description of a trend.

16. The system of claim 15, wherein the request-prompt further comprises an example strategy responsive to the trend.

17. The system of claim 12, wherein the first, second, and third display means are the same means.

18. A system for facilitating the development of strategic options comprising:
first display means for displaying an exercise list identifying a plurality of strategic option exercises;
first selection means, coupled to the first display means, for selecting a strategic option exercise from the exercise list;
second display means, coupled to the first selection means, for displaying a request-prompt associated with the selected strategic option exercise, wherein the request-prompt requests information comprising descriptions of strategic options;
receiving means, coupled to the second display means, for receiving information responsive to the request-prompt;
storing means, coupled to the receiving means, for storing the information received by the receiving means;
processor means, coupled to the storing means, for generating a strategic option list organizing the stored descriptions of the strategic options;
third display means, coupled to the processor means, for displaying the strategic option list;
second selection means, coupled to the third display means, for selecting a strategic option from the strategic option list; and
fourth display means, coupled to the second selection means, for displaying an implementation-prompt, wherein the implementation-prompt requests, for the selected strategic option, information responsive to predetermined implementation criteria.

19. The system of claim 18, wherein the request-prompt comprises a description of an approach to strategic option development.

20. The system of claim 19, wherein the request-prompt further comprises an example strategy exemplifying the approach to strategic option development.

21. The system of claim 18, wherein the request-prompt comprises a description of a trend.

22. The system of claim 21, wherein the request-prompt further comprises an example strategy responsive to the trend.

23. The system of claim 18, wherein the first, second, third, and fourth display means are the same means.

24. A method for facilitating the development of strategic options comprising:
requesting information comprising descriptions of strategic options;
receiving the information;
storing the information;
organizing the information into a list of strategic options;
displaying the list of strategic options;
requesting a selection of a strategic option from the list;
receiving the selection; and
for the selected strategic option, requesting information responsive to predetermined implementation criteria.

25. The method of claim 24, further comprising displaying a prompt describing an approach to strategic option development.

26. The method of claim 25, wherein the prompt comprises an example strategy exemplifying the approach to strategic option development.

27. The method of claim 24, further comprising displaying a prompt comprising a description of a trend.

28. The method of claim 27, wherein the prompt further comprises an example strategy responsive to the trend.

29. A method for facilitating the development of strategic options comprising:
displaying an exercise list identifying a plurality of strategic option exercises;
soliciting a selection of a strategic option exercise from the exercise list;
receiving the selection of the strategic option exercise;
displaying a request-prompt associated with the selected strategic option exercise, wherein the request-prompt requests information comprising descriptions of strategic options;
receiving information responsive to the request-prompt;
organizing the information responsive to the request-prompt into a list of strategic options;
displaying the list of strategic options;
displaying a selection-prompt for a selection of a strategic option;
receiving the selected strategic option; and
for the selected strategic option, requesting information responsive to predetermined implementation criteria.

30. The method of claim 29, wherein the request-prompt comprises a description of an approach to strategic option development.

31. The method of claim 30, wherein the request-prompt further comprises an example strategy exemplifying the approach to strategic option development.

32. The method of claim 29, wherein the request-prompt comprises a description of a trend.

33. The method of claim 32, wherein the request-prompt further comprises an example strategy responsive to the trend.

34. The method of claim 29, further comprising:
soliciting a selection of a second strategic option exercise from the exercise list;
receiving the selection of the second strategic option exercise;
displaying a second request-prompt associated with the selected second strategic option exercise, wherein the second request-prompt requests information comprising descriptions of strategic options;
receiving information responsive to the second request-prompt; and
organizing the information responsive to the second request-prompt into the list of strategic options.

35. A computer-readable medium having computer executable instructions for performing the steps of:
requesting information comprising descriptions of strategic options;
receiving the information;
storing the information;
organizing the information into a list of strategic options;
displaying the list of strategic options;
requesting a selection of a strategic option from the list;
receiving the selection; and
for the selected strategic option, requesting information responsive to predetermined implementation criteria.

36. The computer-readable medium of claim 35, wherein the executable instructions further comprise the step of displaying a prompt describing an approach to strategic option development.

37. The computer-readable medium of claim 36, wherein the prompt comprises an example strategy exemplifying the approach to strategic option development.

38. The computer-readable medium of claim 35, wherein the executable instructions further comprise the step of displaying a prompt comprising a description of a trend.

39. The computer-readable medium of claim 38, wherein the prompt further comprises an example strategy responsive to the trend.

40. A computer-readable medium having computer executable instructions for performing the steps of:
displaying an exercise list identifying a plurality of strategic option exercises;
soliciting a selection of a strategic option exercise from the exercise list;
receiving the selection of the strategic option exercise;
displaying a request-prompt associated with the selected strategic option exercise, wherein the request-prompt requests information comprising descriptions of strategic options;
receiving information responsive to the request-prompt;
organizing the information into a list of strategic options;
displaying the list of strategic options;
displaying a selection-prompt for a selection of a strategic option;
receiving the selected strategic option; and
for the selected strategic option, requesting information responsive to predetermined implementation criteria.

41. The computer-readable medium of claim 40, wherein the request-prompt comprises a description of an approach to strategic option development.

42. The computer-readable medium of claim 41, wherein the request-prompt further comprises an example strategy exemplifying the approach to strategic option development.

43. The computer-readable medium of claim 40, wherein the request-prompt comprises a description of a trend.

44. The computer-readable medium of claim 43, wherein the request-prompt further comprises an example strategy responsive to the trend.

45. The computer-readable medium of claim 40, wherein the executable instructions further comprise:
soliciting a selection of a second strategic option exercise from the exercise list;
receiving the selection of the second strategic option exercise;
displaying a second request-prompt associated with the selected second strategic option exercise, wherein the second request-prompt requests information comprising descriptions of strategic options;
receiving information responsive to the second request-prompt; and
organizing the information responsive to the second request-prompt into the list of strategic options.

46. A system for facilitating the development of strategic options comprising:
a processor, comprising a memory device, connected to a display device and an input device, wherein the memory device stores a program for controlling the processor, and the processor is operative with the program to
display an exercise explanation;
display an example strategic option responsive to the exercise explanation;
display a request-prompt requesting descriptions of strategic options;
receive information responsive to the request-prompt;
store the information received by the input device;
organize the information into a list of strategic options;
display the list and a selection-prompt requesting a selection of a strategic option;
receive the selection; and
display an implementation-prompt requesting, for the selected strategic option, information responsive to predetermined implementation criteria.

47. The system of claim 46, wherein the exercise explanation describes developing strategic options by challenging widely-held beliefs; and the request-prompt requests descriptions of strategic options responsive to challenging widely-held beliefs.

48. The system of claim 46, wherein the exercise explanation describes developing strategic options by identifying an analogy; and the request-prompt requests descriptions of strategic options responsive to the analogy.

49. The system of claim 46, wherein the exercise explanation describes developing strategic options by identifying a discontinuity; and the request-prompt requests descriptions of strategic options responsive to the discontinuity.

50. The system of claim 46, wherein the exercise explanation describes developing strategic options by altering a metric; and the request-prompt requests descriptions of strategic options responsive to the altered metric.

51. The system of claim 46, wherein the exercise explanation describes developing strategic options by identifying a constraint; and the request-prompt requests descriptions of strategic options responsive to exceeding the constraint.

52. The system of claim 46, wherein the exercise explanation describes developing strategic options by identifying an extreme implementation of a business; and the request-prompt requests descriptions of strategic options responsive to the extreme implementation.

53. The system of claim 46, wherein the exercise explanation describes developing strategic options by identifying a capability of a business; and the request-prompt requests descriptions of strategic options responsive to the capability.

54. The system of claim 46, wherein the exercise explanation describes developing strategic options by identifying a use of a first product; and the request-prompt requests descriptions of strategic options, wherein the strategic options comprise descriptions of an alternate product substantially serving the use of the first product.

55. The system of claim 46, wherein the exercise explanation describes developing strategic option by identifying a conventionally recognized limit; and the request-prompt requests descriptions of strategic options responsive to exceeding the conventionally recognized limit.

56. The system of claim 46, wherein the exercise explanation describes developing strategic options by identifying a limit placed on a business by a legacy; and the request-prompt requests descriptions of strategic options responsive exceeding the limit.

57. The system of claim 46, wherein the exercise explanation describes developing strategic options by identifying a development that could negatively affect a business; and the request-prompt requests descriptions of strategic options responsive to the development.

58. The system of claim 46, wherein the exercise explanation describes developing strategic options by identifying a weakness of a business; and the request-prompt requests descriptions of strategic options responsive to the weakness.

59. The system of claim 46, wherein the exercise explanation describes developing strategic options by identifying a substantially risky strategy; and the request-prompt requests descriptions strategic options responsive to the substantially risky strategy.

60. The system of claim 46, wherein the exercise explanation describes developing strategic options by identifying a perceived limitation on a business; and the request-prompt requests descriptions of strategic option responsive to exceeding the perceived limitation.
